(19) United States
(12) Patent Application Publication
(10) Pub. No.: US 2008/0225177 A1
(43) Pub. Date: Sep. 18, 2008

(54) APPARATUS AND METHOD FOR CORRECTING SOLID-STATE ELECTRONIC IMAGE SENSING DEVICE

(76) Inventor: Hirofumi HORII, Asaka-shi (JP)

Correspondence Address: BIRCH STEWART KOLASCH & BIRCH, PO BOX 747, FALLS CHURCH, VA, 22040-0747, US

(21) Appl. No.: 12/041,861

(22) Filed: Mar. 4, 2008

(30) Foreign Application Priority Data
Mar. 15, 2007 (JP) 2007-065953

(51) Int. Cl. H04N 5/14

(52) U.S. Cl. 348/576; 348/E05.062

(57) ABSTRACT

Signal charge is branched in either of two directions, namely to a first output circuit or to a second output circuit, by a branching portion at the left end of a horizontal transfer line. Imperfect transfer of signal charge occurs at the branching portion owing to the branching operation, and this signal charge is added to signal charge of the next pixel. Data representing an amount of correction that corrects for the imperfect transfer is calculated, and imperfect transfer at the branching portion is compensated for using the data representing this amount of correction.

### BACKGROUND OF THE INVENTION

1. Field of the Invention

This invention relates to an apparatus and method for correcting a solid-state electronic image sensing device.

2. Description of the Related Art

In a solid-state electronic image sensing device such as CCD known in the art, the photoreceptor area of the solid-state electronic image sensing device is divided into two photoreceptor areas and two output amplifying circuits are provided in association with respective ones of these two photoreceptor areas. Each output amplifying circuit converts signal charge to a video signal, which is then output from the solid-state electronic image sensing device. Since there are occasions where the conversion efficiencies of the two output amplifying circuits differ, there are instances where a correction is applied in accordance with the particular output amplifying circuit. For example, see the specifications of Japanese Patent Application Laid-Open Nos. 2005-64758 and 2005-64760.

In a solid-state electronic image sensing device in which the output end of one horizontal transfer line is provided with a branching portion that branches the signal charge in two directions, there are instances where signal charge to be transferred remains at the branching portion. It is necessary to correct for such imperfect transfer of signal charge in such a solid-state electronic image sensing device.

### SUMMARY OF THE INVENTION

Accordingly, an object of the present invention is to correct for imperfect transfer of signal charge at a branching portion.

According to the present invention, the foregoing object is attained by providing an apparatus for correcting a solid-state electronic image sensing device having a number of optoelectronic transducers provided in horizontal and vertical directions; a horizontal transfer line, which is provided with a branching portion that branches signal charge in two directions, for transferring one line of signal charge at a time, the signal charge having accumulated in the number of optoelectronic transducers; a first amplifying circuit for converting signal charge, which is output from one of the signal charges branched in the two directions at the branching portion, to a first video signal and then outputting the first video signal; and a second amplifying circuit for converting signal charge, which is output from the other of the signal charges branched in the two directions at the branching portion, to a second video signal and then outputting the second video signal; the apparatus comprising: a driving device responsive to a branching operation command for driving the branching portion in such a manner that the signal charge transferred on the horizontal transfer line is applied to the first amplifying circuit or second amplifying circuit alternatingly, and responsive to a single-line operation command for driving the branching portion in such a manner that the signal charge transferred on the horizontal transfer line is input to either the first amplifying circuit or second amplifying circuit alone; and a first correcting device responsive to the branching operation command for applying a correction, which is based upon imperfect transfer of signal charge at the branching portion, to the first video signal that is output from the first amplifying circuit and to the second video signal that is output from the second amplifying circuit, and responsive to the single-line operation command for halting the correction, which is based upon imperfect transfer of signal charge at the branching portion, applied to the video signal that is output from either the first amplifying circuit or second amplifying circuit alone.

The present invention also provides a correction method suited to the above-described apparatus for correcting a solid-state electronic image sensing device. Specifically, there is provided a method of correcting a solid-state electronic image sensing device having a number of optoelectronic transducers provided in horizontal and vertical directions; a horizontal transfer line, which is provided with a branching portion that branches signal charge in two directions, for transferring one line of signal charge at a time, the signal charge having accumulated in the number of optoelectronic transducers; a first amplifying circuit for converting signal charge, which is output from one of the signal charges branched in the two directions at the branching portion, to a first video signal and then outputting the first video signal; and a second amplifying circuit for converting signal charge, which is output from other of the signal charges branched in the two directions at the branching portion, to a second video signal and then outputting the second video signal; the method comprising the steps of: in response to a branching operation command, driving the branching portion by a driving device in such a manner that the signal charge transferred on the horizontal transfer line is applied to the first amplifying circuit or second amplifying circuit alternatingly, and in response to a single-line operation command, driving the branching portion by the driving device in such a manner that the signal charge transferred on the horizontal transfer line is input to either the first amplifying circuit or second amplifying circuit alone; and in response to the branching operation command, applying, by a correcting device, a correction, which is based upon imperfect transfer of signal charge at the branching portion, to the first video signal that is output from the first amplifying circuit and to the second video signal that is output from the second amplifying circuit, and in response to the single-line operation command, halting, by the correcting device, the correction, which is based upon imperfect transfer of signal charge at the branching portion, applied to the video signal that is output from either the first amplifying circuit or second amplifying circuit alone.

The present invention is such that when a branching operation command is applied, a branching portion is driven in such a manner that signal charge transferred on a horizontal transfer line is input alternatingly to either a first or a second amplifying circuit. In response to the branching operation command, a correction, which is based upon imperfect transfer of signal charge at the branching portion, is applied to the first video signal that is output from the first amplifying circuit and to the second video signal that is output from the second amplifying circuit. Even if imperfect transfer of signal charge at the branching portion occurs, a video signal that has been corrected for imperfect transfer is obtained. When a single-line operation command is applied, the driving portion is driven in such a manner that signal charge transferred on the horizontal transfer line is input to either the first amplifying circuit or second amplifying circuit alone. In a case where the single-line operation command has been applied, it is believed that the amount of imperfect transfer of signal charge at the branching portion will be small. Accordingly, the correction based upon imperfect transfer of signal charge at the branching portion is stopped from being applied to the video signal that is output from either the first amplifying circuit or second amplifying circuit alone.

The apparatus may further comprise a second correcting device responsive to the branching operation command for applying a correction, which is based upon imperfect transfer of signal charge in the first amplifying circuit, to the first video signal that is output from the first amplifying circuit, and applying a correction, which is based upon imperfect transfer of signal charge in the second amplifying circuit, to the second video signal that is output from the second amplifying circuit, and responsive to the single-line operation command for canceling the halting of the correction, which is based upon imperfect transfer of signal charge at the branching portion, applied to the video signal that is output from either the first amplifying circuit or second amplifying circuit alone, and applying a correction based upon imperfect transfer of signal charge in whichever of the first or second amplifying circuit has output the video signal.

By way of example, when transfer driving frequency of signal charge on the horizontal transfer line is less than a prescribed threshold value, the first correcting device halts the correction, which is based upon imperfect transfer of signal charge at the branching portion, to be applied in response to the branching operation command.

The apparatus may further comprise an output device responsive to the branching operation command for outputting the first video signal that is output from the first amplifying circuit, the second video signal that is output from the second amplifying circuit, and a correction parameter for applying the correction based upon imperfect transfer of signal charge at the branching portion.

By way of example, the output device halts the output of the correction parameter when the transfer driving frequency of signal charge on the horizontal transfer line is less than a prescribed threshold value.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic view of a CCD;

FIGS. 2A to 7F illustrate the manner in which signal charge is transferred;

FIG. 8 is a flowchart illustrating correction processing;

FIG. 9 is a block diagram of a digital still camera;

FIG. 10 is a graph illustrating amount of correction;

FIG. 11 is a flowchart illustrating correction processing; and

FIGS. 12 to 14 are flowcharts illustrating processing executed by a digital still camera according to other embodiments of the present invention.

### DESCRIPTION OF THE PREFERRED EMBODIMENTS

Preferred embodiments of the present invention will now be described in detail with reference to the accompanying drawings.

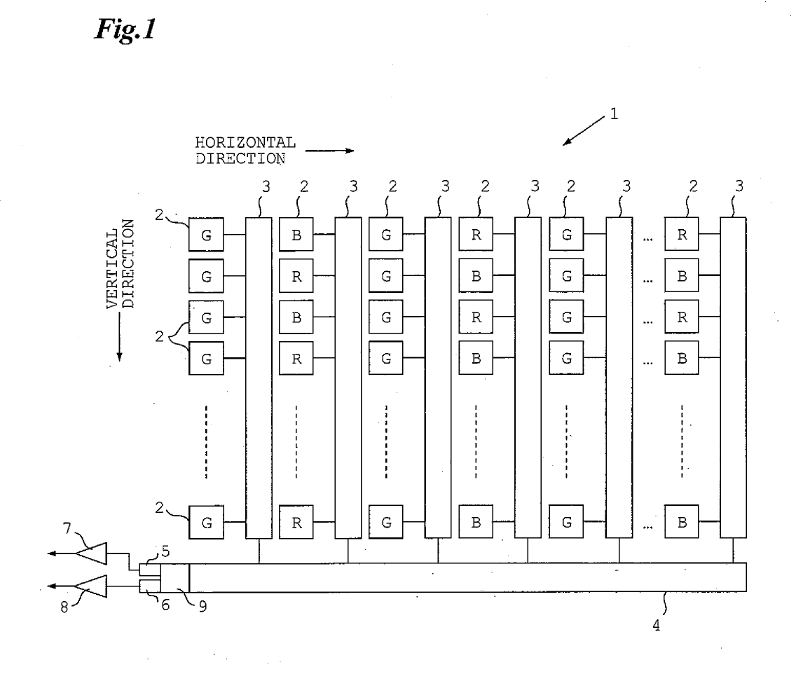

FIG. 1 is a schematic view illustrating a CCD 1 according to an embodiment of the present invention.

The CCD 1 is provided with a number of photodiodes (optoelectronic transducers) in the horizontal and vertical directions. A filter (indicated by G) that transmits a green color component, a filter (indicated by B) that transmits a blue color component or a filter (indicated by R) that transmits a red color component is formed on the photoreceptor surface of each photodiode 2. A vertical transfer line 3 is provided on the right side of each column of the photodiodes 2. The vertical transfer lines 3 are for transferring signal charge that has accumulated in the photodiodes 2, the signal charge representing the green, blue and red color components. A horizontal transfer line 4 for horizontally transferring signal charge that has been transferred from the vertical transfer lines 3 is provided at the output ends (lower side) of the vertical transfer lines 3.

The CCD 1 according to this embodiment is such that signal charge that has been transferred within the horizontal transfer line 4 can be output upon being branched in two directions. To achieve this, the output end of the horizontal transfer line 4 on the left side thereof is provided with a branching portion 9 for branching the signal charge in two directions. The branching portion 9 is provided with a first connector 5 whereby signal charge branched in one of the two directions is transferred to a first output circuit (first amplifying circuit) 7, and with a second connector 6 whereby signal charge branched in the other of the two directions is transferred to a second output circuit (first amplifying circuit) S. Signal charge that has been applied to the first output circuit 7 is output upon being converted to a first video signal. Signal charge that has been applied to the second output circuit 8 is output upon being converted to a second video signal.

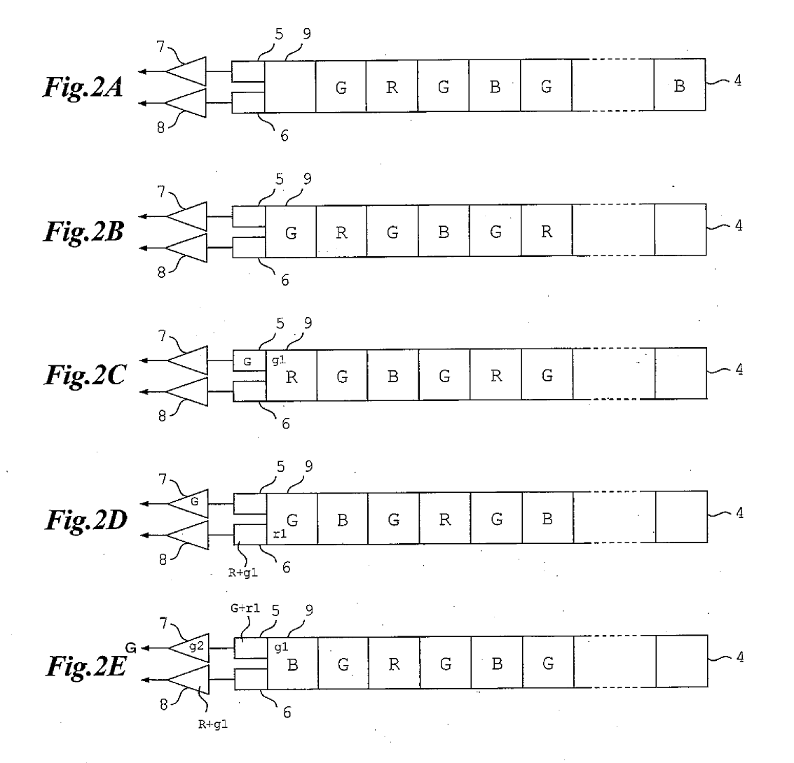

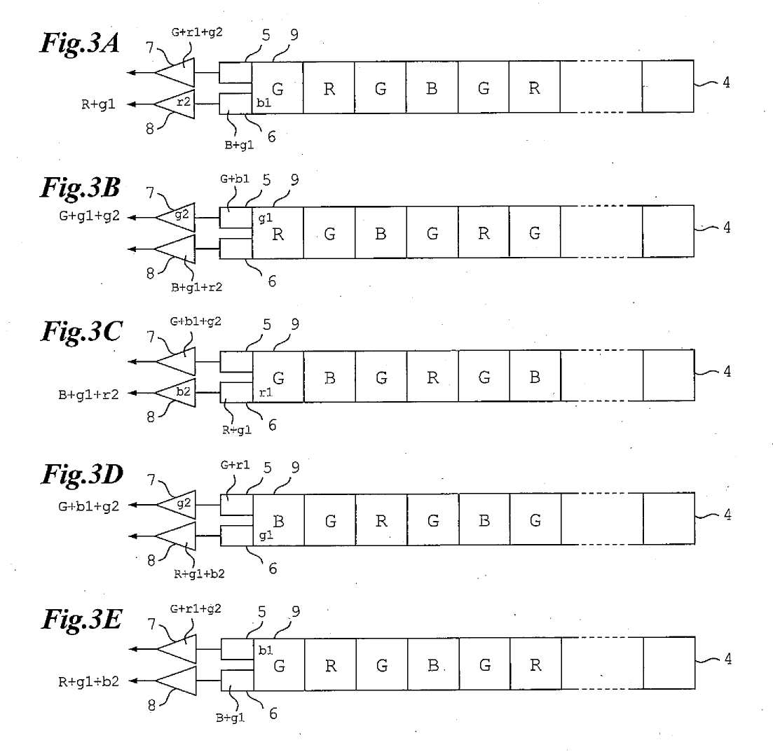

FIGS. 2A to 2E and FIGS. 3A to 3E illustrate the manner in which signal charge is transferred in the horizontal direction on the horizontal transfer line 4. The signal charge is transferred while being branched. Signal charge representing the green color component is indicated by G, signal charge representing the blue color component is indicated by B, and signal charge representing the red color component is indicated by R in these drawings.

If signal charge that has accumulated in the photodiodes 2 is shifted to the vertical transfer lines 3 and a vertical transfer pulse is applied to the vertical transfer lines 3, signal change that had accumulated in the photodiodes of the lowermost row of the CCD 1 is applied to the horizontal transfer line 4, as illustrated in FIG. 2A. The signal charge accumulates in potential wells formed under horizontal transfer electrodes of the horizontal transfer line 4.

If a horizontal transfer pulse is applied to the horizontal transfer line 4, the signal charge that has accumulated in the potential wells formed under the horizontal transfer electrodes of the horizontal transfer line 4 is shifted leftward by one potential well under the horizontal transfer electrodes, as illustrated in FIG. 2B. (It goes without saying that the potential wells formed under the horizontal transfer electrodes have been formed to have potential barriers in such a manner that there will be no mixing of mutually adjacent signal charge.) When this occurs, the signal charge G on the leftmost side is input to the branching portion 9.

Next, if a horizontal transfer pulse is applied to the horizontal transfer line 4, signal charge is shifted leftward by one potential well under the horizontal transfer electrodes, as illustrated in FIG. 2C. As a result, the signal charge G on the leftmost side is applied to the first connector 5. The signal charge R is input to the branching portion 9. In a case where a branching operation is performed at the branching portion 9, not all of the signal charge that has been applied to the branching portion 9 is transferred to the first connector 5 or second connector 6; some signal charge g1 remains in the branching portion 9 (i.e., imperfect transfer occurs in the branching portion 9). At the branching portion 9, therefore, the signal charge g1 resulting from imperfect transfer is added to signal charge R, which has entered the branching portion 9.

If a further horizontal transfer pulse is applied to the horizontal transfer line 4, signal charge is shifted further leftward by one potential well under the horizontal transfer electrodes, as illustrated in FIG. 2D. Signal charge G on the leftmost side is input from the first connector 5 to the first output circuit 7, and signal charge R+g1 resulting from the addition in the branching portion 9 is input to the second connector 6 by the branching operation of the branching portion 9. Further, signal charge r1 resulting from imperfect transfer of the signal charge R remains and this is added to the next signal charge, which is signal charge G.

If a further horizontal transfer pulse is applied to the horizontal transfer line 4, a first video signal representing the signal charge G is output from the first output circuit 7, as illustrated in FIG. 2E. Signal charge g2 resulting from imperfect transfer of the signal charge G remains in the first output circuit 7. Since signal charge r1 resulting from imperfect transfer exists in branching portion 9 and is added to signal charge G, as mentioned above, signal charge that is the result of adding the signal charge G and the signal charge r1 from imperfect transfer is input to the first connector 5. The signal charge g1, which is the result of imperfect transfer of signal charge G transferred to the first connector 5, remains in the branching portion 9. Signal charge B, which follows the signal charge G, enters the branching portion 9 and is added to the signal charge g1 resulting from imperfect transfer. The signal charge R and the signal charge g1 resulting from imperfect transfer in the branching portion 9 are input to the second output circuit 8.

If a further horizontal transfer pulse is applied to the horizontal transfer line 4, not only the applied signal charge G and signal charge r1 resulting from imperfect transfer of the branching portion 9 but also a signal charge g2, which is the result of imperfect transfer of transferred charge in the first output circuit 7, are added in the first output circuit 7, as illustrated in FIG. 3A. The second output circuit 8 outputs a second video signal representing the signal charge R+g1 that is the result of adding the signal charge g1, which results from imperfect transfer, to the signal charge R. Signal charge r2 resulting from imperfect transfer of signal charge R in the second output circuit 8 remains in the second output circuit 8. Signal charge B and the signal charge g1 resulting from imperfect transfer in the branching portion 9 enter the second connector 6. Signal charge b1 resulting from imperfect transfer of the signal charge B remains in the branching portion 9 and is added to the next signal charge, which is signal charge G.

If a further horizontal transfer pulse is applied to the horizontal transfer line 4, the first output circuit 7 outputs a first video signal representing G+g1+g2, which is the result of adding the signal charge g1 resulting from imperfect transfer in the branching portion and signal charge g2 resulting from imperfect transfer in the first output circuit 7 to the signal charge G, as illustrated in FIG. 3B. The signal charge g2 resulting from imperfect transfer of the signal charge G that has been output from the first output circuit 7 remains in the first output circuit 7. The signal charge G1 supplied from the first output circuit 7 and signal charge b1 resulting from imperfect transfer in the branching portion 9 are input to the first connector 5. The signal charge B supplied from the second connector 6 and signal charge g1 resulting from imperfect transfer in the branching portion 9 are input to the second output circuit 8, and these are added to the signal charge r2 resulting from imperfect transfer in the second connector 6 remaining in the second connector 6. Signal charge g1 resulting from imperfect transfer of the signal charge G remains in the branching portion 9 and is added to the next signal charge, which is signal charge R.

If a further horizontal transfer pulse is applied to the horizontal transfer line 4, the signal charge g2 resulting from imperfect transfer in the first output circuit 7 is added to the signal charge G that entered from the first connector 5 and to the signal charge g1 resulting from imperfect transfer in the branching portion 9, as illustrated in FIG. 3C. The second output circuit 8 outputs the second video signal representing signal charge B+g1+r2 that is the result of adding the signal charge g1 resulting from imperfect transfer in the branching portion 9 and the signal charge r2 resulting from imperfect transfer in the second output circuit 8 to the signal charge B. Signal charge b2 resulting from imperfect transfer in the second output circuit 8 remains in the second output circuit 8, and the signal charge g1 resulting from imperfect transfer in the branching portion 9 is applied to the second connector 6 and added to the signal charge R. The signal charge r1 resulting from imperfect transfer in the branching portion 9 remains in the branching portion 9 and is added to the next signal charge, which is signal charge G.

If a further horizontal transfer pulse is applied to the horizontal transfer line 4, the first output circuit 7 outputs the second video signal representing signal charge G+b1+g2 that is the result of adding the signal charge g2 resulting from imperfect transfer in the first output circuit 7 and the signal charge b1 resulting from imperfect transfer in the branching portion 9 to the signal charge C, as illustrated in FIG. 3D. Signal charge g2 resulting from imperfect transfer remains in the first output circuit 7. The signal charge r1 resulting from imperfect transfer in the branching portion 9 is input to the first connector 5 and added to the signal charge G supplied from the branching portion 9. The signal charge R supplied from the second connector 6, the signal charge g1 resulting from imperfect transfer in the branching portion 9 and signal charge b2 resulting from imperfect transfer in the second output circuit 8 are added in the second output circuit 8. The signal charge g1 resulting from imperfect transfer of the signal charge G remains in the branching portion 9 and is added to the next signal charge, which is signal charge B.

If a further horizontal transfer pulse is applied to the horizontal transfer line 4, signal charge r1 resulting from imperfect transfer in the branching portion 9 and signal charge g2 resulting from imperfect transfer in the first output circuit 7 are added to the signal charge G, as illustrated in FIG. 3E. The second output circuit 8 outputs the second video signal R+g1+b2 representing signal charge that is the result of adding the signal charge g1 resulting from imperfect transfer in the branching portion 9 and the signal charge b2 resulting from imperfect transfer in the second output circuit 8 to the signal charge R. The signal charge g1 resulting from imperfect transfer in the branching portion 9 is input to the second connector 6 and added to the signal charge B supplied from the branching portion 9. The signal charge b1 resulting from imperfect transfer remains in the branching portion 9 and is added to the next signal charge, which is signal charge G.

Thus, imperfect transfer of signal charge occurs in the branching portion 9, in the first output circuit 7 and in the second output circuit 8.

In this embodiment, a correction is made for the video signal component produced by such imperfect transfer of signal charge in the branching portion 9 and for the video signal components produced by such imperfect transfer in the first output circuit 7 and imperfect transfer in the second output circuit 8.

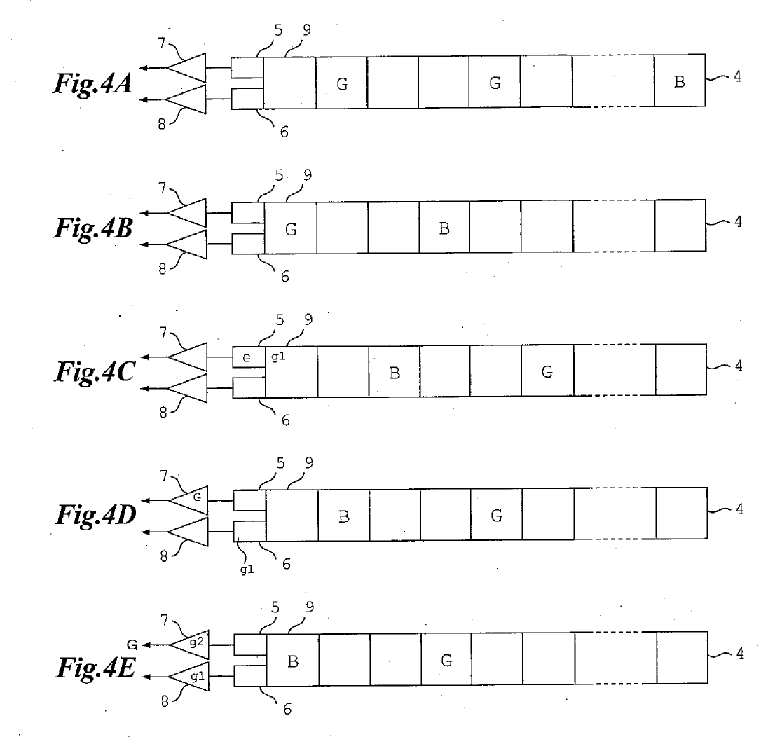

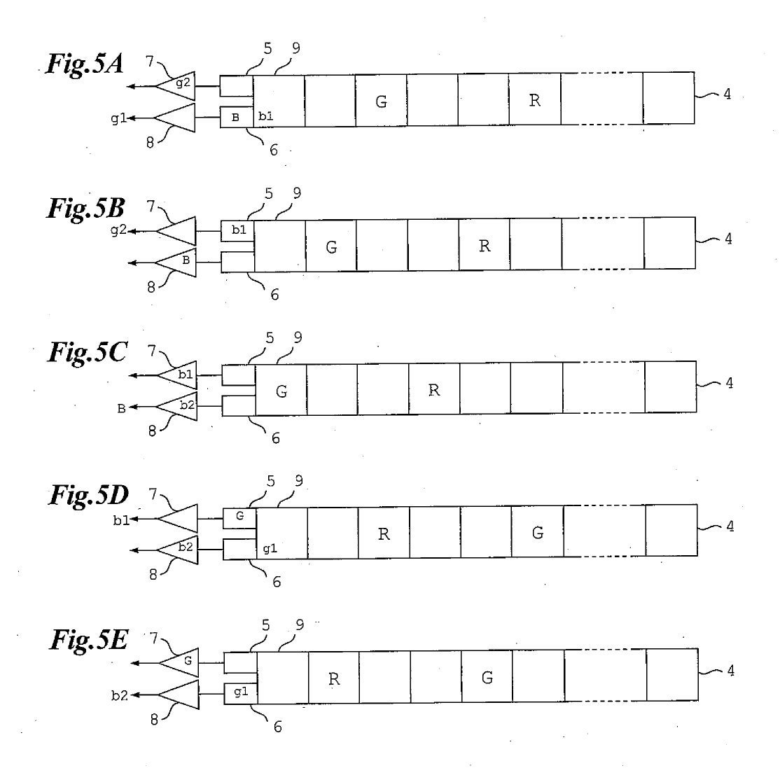

FIGS. 4A to 4E and FIGS. 5A to 5E illustrate the manner in which signal charge is transferred in the horizontal direction on the horizontal transfer line 4. These illustrate the manner of branched transfer for calculating amounts of correction for the purpose of applying the correction mentioned above.

In FIGS. 2A to 2E and FIGS. 3A to 3E, signal charge that has accumulated in all photodiodes 2 of the CCD 1 are output by branched transfer. In a case where the amount of correction is calculated, however, signal charge is output at a ratio of one column to three columns. The CCD 1 is driven in such a manner that signal charge that has accumulated in the remaining two columns of the three columns is not output from the CCD 1. In order to drive the CCD 1 in such a manner that the signal charge that has accumulated in the remaining two columns of the three columns is not output, the shifting of signal charge that has accumulated in the photodiodes 2 from the photodiodes 2 to the vertical transfer line 3 may be halted at a ratio of two columns to three columns, or the shifting of this signal charge from the vertical transfer line 3 to the horizontal transfer line 4 may be halted at a ratio of two columns to three columns.

With reference to FIG. 4A, signal charge is input to the horizontal transfer line 4 every three pixels. Since signal charge is not applied to the potential wells that are between the potential wells where signal charge input to the horizontal transfer line 4 has accumulated, these potential wells are empty. If a horizontal transfer pulse is applied to the horizontal transfer line 4, signal charge that has accumulated in the horizontal transfer line 4 is transferred leftward by one potential well under the horizontal transfer electrodes, as illustrated in FIG. 4B, in the manner described above. If a further horizontal transfer pulse is applied, the signal charge G on the leftmost side is input to the first connector 5, as illustrated in FIG. 4C. Signal charge g1 resulting from imperfect transfer of the signal charge C remains in the branching portion 9. Since signal charge is applied to the horizontal transfer line 4 every three pixels, there is no signal charge that follows the signal charge G on the leftmost side. Consequently, there is no input of succeeding signal charge to the branching portion 9 and only the signal charge g1 resulting from imperfect transfer in the branching portion 9 remains.

If a further horizontal transfer pulse is applied to the horizontal transfer line 4, the signal charge G on the leftmost side is input to the first output circuit 7, as illustrated in FIG. 4D. Only the signal charge g1 resulting from imperfect transfer in the branching portion 9 is input to the second connector 6. If a further horizontal transfer pulse is applied to the horizontal transfer line 4, the first output circuit 7 outputs the first video signal representing the signal charge G, as illustrated in FIG. 4E. Signal charge g2 resulting from imperfect transfer of the signal charge G in the first output circuit 7 remains in the first output circuit 7. The signal charge g1 resulting from imperfect transfer in the branching portion 9 supplied from the second connector 6 is input to the second output circuit 8. The next signal charge, which is signal charge B, enters the branching portion 9.

If a further horizontal transfer pulse is applied to the horizontal transfer line 4, the second output circuit 8 outputs the second video signal representing the signal charge g1 resulting from imperfect transfer in the branching portion 9, as illustrated in FIG. 5A. The signal charge B that has entered the branching portion 9 enters the second connector 6, and signal charge b1 resulting from imperfect transfer of the signal charge B remains in the branching portion 9. If a further horizontal transfer pulse is applied to the horizontal transfer line 4, the first output circuit 7 outputs the signal charge g2 resulting from imperfect transfer in the first output circuit 7, as illustrated in FIG. 5B. The signal charge b1 resulting from imperfect transfer in the branching portion 9 enters the first connector 5 from the branching portion 9. The signal charge B is input to the second output circuit 8.

If a further horizontal transfer pulse is applied to the horizontal transfer line 4, then the signal charge b1 resulting from imperfect transfer in the branching portion 9 is input to the first output circuit 7, as illustrated in FIG. 5C. The second output circuit 8 outputs the second video signal representing the signal charge B. The signal charge b2 resulting from imperfect transfer in the second output circuit 8 remains in the second output circuit 8. The next signal charge G enters the branching portion 9. If a further horizontal transfer pulse is input to the horizontal transfer line 4, then the first output circuit 7 outputs the first video signal representing the signal charge b1 resulting from imperfect transfer in the branching portion 9, as illustrated in FIG. 5D. The signal charge G that has been output from the branching portion 9 enters the first connector 5, and the signal charge g1 resulting from imperfect transfer of the signal charge G remains in the branching portion 9. The signal charge b2 resulting from imperfect transfer in the second output circuit 8 remains in the second output circuit 8.

If a further horizontal transfer pulse is input to the horizontal transfer line 4, the signal charge G enters the first output circuit 7, as illustrated in FIG. 5E. The second output circuit 8 outputs the second video signal representing the signal charge b2 resulting from imperfect transfer in the second output circuit 8. The signal charge g1 resulting from imperfect transfer in the branching portion 9 is input to the second connector 6.

Since a video signal corresponding to the signal charge g1 resulting from imperfect transfer in the branching portion 9 is output from the second output circuit 8, as illustrated in FIG. 5A, the amount of correction for imperfect transfer in the branching portion 9 can be determined. Further, since a video signal corresponding to the signal charge g2 resulting from imperfect transfer in the first output circuit 7 is output from the first output circuit 7, as illustrated in FIG. 5B, the amount of correction for imperfect transfer in the first output circuit 7 can be determined. Furthermore, since a video signal corresponding to the signal charge b2 resulting from imperfect transfer in the second output circuit 8 is output from the second output circuit 8, as illustrated in FIG. 5E, the amount of correction for imperfect transfer in the second output circuit 8 can be determined. By using these amounts of correction, it is possible to apply a correction for the imperfect transfer in the branching portion 9, a correction for the imperfect transfer in the branching portion 9 and a correction for the imperfect transfer in the second output circuit 8.

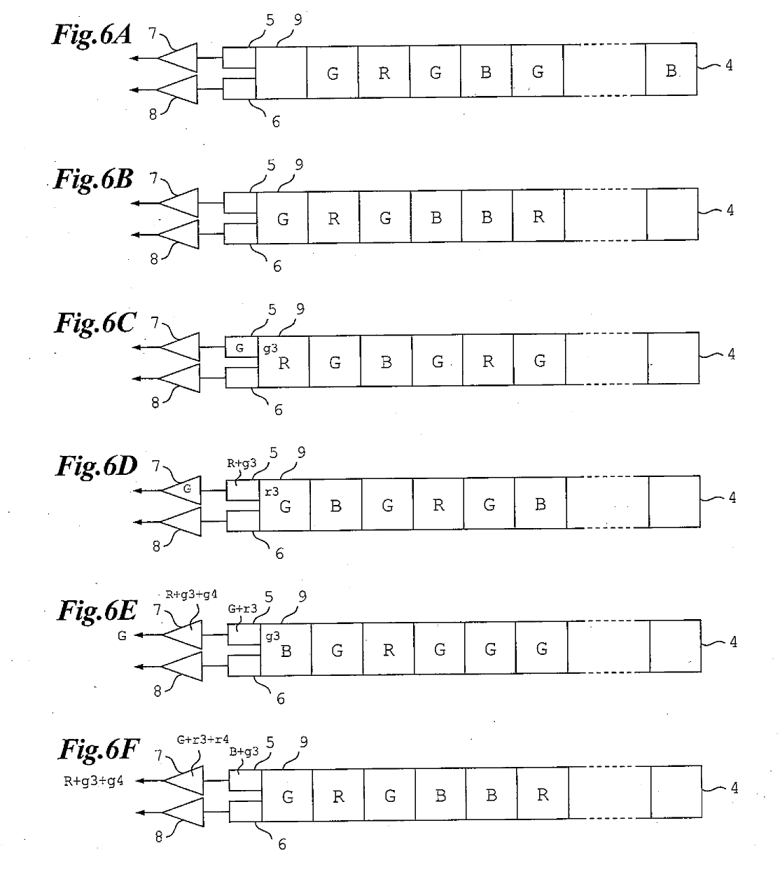

FIGS. 6A to 6F illustrate the manner in which signal charge is transferred in the horizontal direction on the horizontal transfer line 4. These illustrate single-line transfer, in which branching processing is not executed.

With single-line transfer in this embodiment, the first connector 5 and first output circuit 7 are used but not the second connector 6 and second output circuit B. However, it may be so arranged that the second connector 6 and second output circuit 8 are used but not the first connector 5 and first output circuit 7.

As illustrated in FIG. 6A, signal charge that has accumulated in the photodiodes 2 of the lowermost row is input to and accumulates in the horizontal transfer line 4. If a horizontal transfer pulse is applied to the horizontal transfer line 4, the signal charge that has accumulated in the horizontal transfer line 4 is shifted leftward by one pixel, as illustrated in FIG. 6B. Signal charge G on the leftmost side is input to the branching portion 9.

If a further horizontal transfer pulse is applied to the horizontal transfer line 4, the signal charge C on the leftmost side is input to the first connector 5, as illustrated in FIG. 6C. When this occurs, signal charge g3 resulting from imperfect transfer of the signal charge G is produced in the branching portion 9 and is added to the next signal charge, which is signal charge R. If a further horizontal transfer pulse is applied to the horizontal transfer line 4, the signal charge G on the leftmost side is input to the first output circuit 7, as illustrated in FIG. 6D. Signal charge R+g3, which is the result of adding the next signal charge R and the signal charge g3 resulting from imperfect transfer in the branching portion 9, is input to the first connector 5.

If a further horizontal transfer pulse is applied to the horizontal transfer line 4, the first connector 5 outputs a video signal representing the signal charge A, as illustrated in FIG. 6E. Signal charge g4 resulting from imperfect transfer in the first connector 5 remains in the first connector 5 and is added to the signal charge R that has entered from the first connector 5 and the signal charge g3 resulting from imperfect transfer in the branching portion 9. If a further horizontal transfer pulse is applied to the horizontal transfer line 4, the first output circuit 7 outputs a video signal corresponding to signal charge R+g3+g4 that is the result of adding the signal charge gB resulting from imperfect transfer in the branching portion 9 and signal charge g4 resulting from imperfect transfer in the first output circuit 7 to the signal charge R, as illustrated in FIG. 6F.

Thus, in single-line transfer as well, the video signal that is output represents signal charge that is the result of adding signal charge resulting from imperfect transfer in the branching portion 9 and signal charge resulting from imperfect transfer in the first output circuit 7.

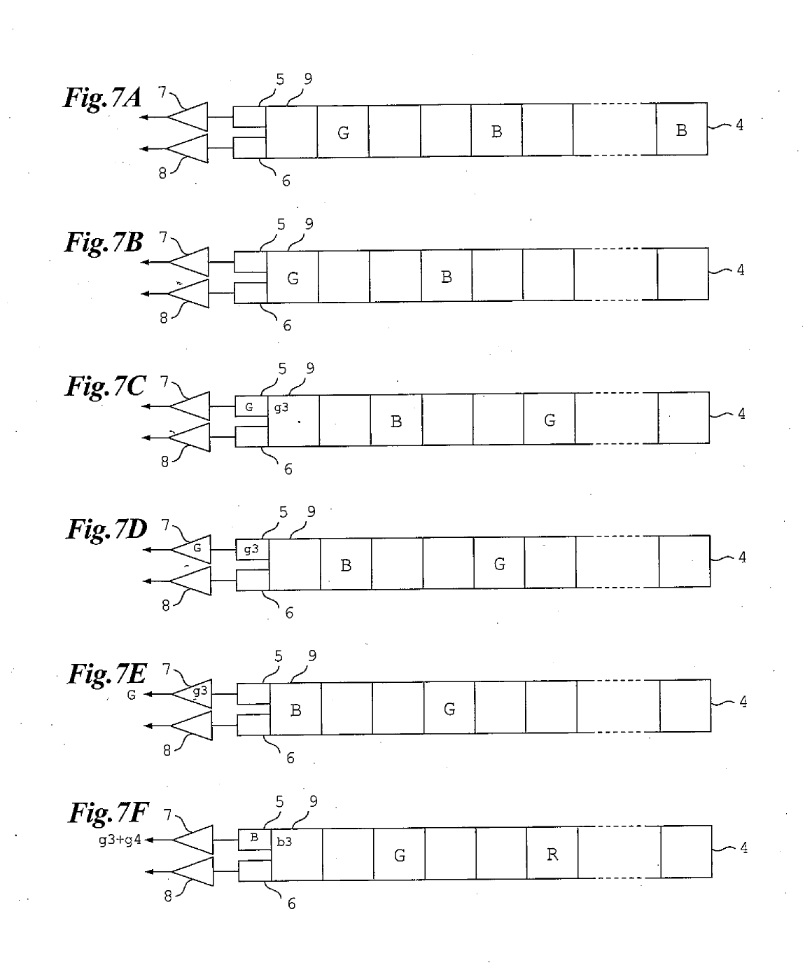

FIGS. 7A to 7F illustrate the manner in which signal charge is transferred in the horizontal direction by single-line transfer. These illustrate single-line transfer for calculating amounts of correction for the purpose of applying the correction mentioned above.

In this case also where amount of correction in single-line transfer is calculated, signal charge that has accumulated in the photodiodes 2 is applied to the horizontal transfer line 4 at a ratio of one column to three columns. If a horizontal transfer pulse is applied to the horizontal transfer line 4, signal charge is shifted leftward by one pixel, as illustrated in FIG. 7B. The signal charge G on the leftmost side is input to the branching portion 9.

If a further horizontal transfer pulse is applied to the horizontal transfer line 4, the signal charge G on the leftmost side is input to the first connector 5 and the signal charge g3 resulting from imperfect transfer remains in the branching portion 9, as illustrated in FIG. 7C. Since the signal charge that follows the signal charge G has not been shifted to the horizontal transfer line 4, only the signal charge g3 resulting from imperfect transfer in the branching portion 9 remains in the branching portion 9. If a further horizontal transfer pulse is applied to the horizontal transfer line 4, the signal charge G is input to the first output circuit 7 and the signal charge g3 resulting from imperfect transfer in the branching portion 9 is input to the first connector 5.

If a further horizontal transfer pulse is applied to the horizontal transfer line 4, a video signal representing the signal charge G is output from the first output circuit 7, as illustrated in FIG. 7E. Signal charge g4 resulting from imperfect transfer in the first output circuit 7 remains in the first output circuit 7, and the signal charge g3 resulting from imperfect transfer in the branching portion 9 that is output from the first connector 5 is input to the first output circuit 7. If a further horizontal transfer pulse is applied to the horizontal transfer line 4, the first output circuit 7 outputs a video signal representing the signal charge g3 resulting from imperfect transfer in the branching portion 9 and the signal charge g4 resulting from imperfect transfer in the first output circuit 7. Since the signal charge g3 resulting from imperfect transfer in the branching portion 9 and the signal charge g4 resulting from imperfect transfer in the first output circuit 7 can thus be determined, it is possible to determine an amount of correction that is based upon the imperfect transfer in the branching portion 9 and the imperfect transfer in the first output circuit 7 in single-line transfer. (Imperfect transfer in the second output circuit 8 can be ascertained in similar fashion.) The signal charge g4 resulting from imperfect transfer in the first output circuit 7 from which imperfect transfer in the branching portion 9 has been eliminated in single-line transfer is the same as the signal charge g2 resulting from imperfect transfer in the first output circuit 7 in branched transfer described above. Thus, the signal charge g4 resulting from imperfect transfer in the first output circuit 7 from which imperfect transfer in the branching portion 9 has been eliminated in single-line transfer can also be detected.

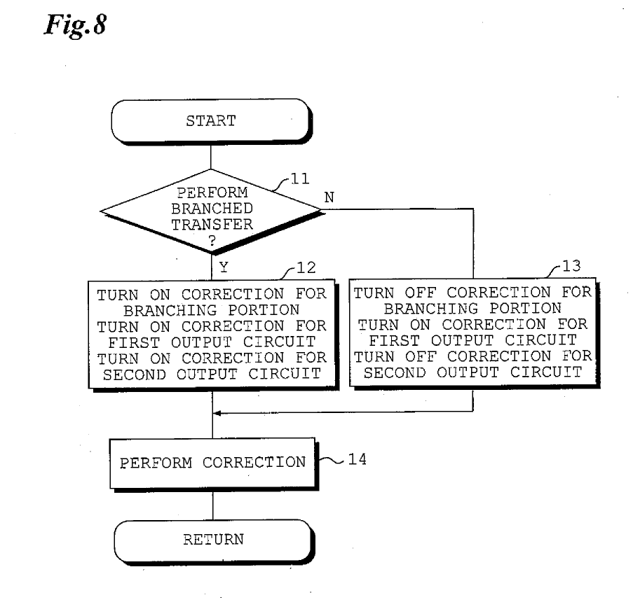

FIG. 8 is a flowchart illustrating processing in a case where correction processing is executed. The correction processing changes the content of the correction in dependence upon whether or not the above-described branched transfer is performed in the CCD 1.

If the above-described branched transfer is performed in the CCD 1 (“YES” at step 11), signal charge that has been transferred on the horizontal transfer line 4 is branched at the branching portion 9 so as to be applied to the first output circuit 7 or second output circuit 8. As a result, it is set so that all of the corrections are made, namely correction of the branching portion to correct for imperfect transfer resulting from the branching operation in the branching portion 9, correction of the first output circuit to correct for imperfect transfer in the first output circuit 7 and correction of the second output circuit to correct for imperfect transfer in the second output circuit 8 (step 12).

If the above-described branched transfer is not performed in the CCD 1 (“NO” at step 11; execution of signal-line transfer), then signal charge is applied to the first output circuit 7 without executing the branching operation in the branching portion 9. When single-line transfer is performed, imperfect transfer in the branching portion 9 is believed to be negligible and it is set so that the correction for correcting for imperfect transfer in the first output circuit 7 is carried out but not the correction of the branching portion for correcting for imperfect transfer in the branching portion 9. It goes without saying that the amount of correction for imperfect transfer in the first output circuit 7 is obtained as illustrated in FIG. 5B. Further, since signal charge is not applied to the second output circuit 8, it is set so that the correction for correcting for imperfect transfer in the second output circuit 8 is not carried out (step 13).

It goes without saying that in a case where signal charge is applied to the second output circuit 8 but not to the first output circuit 7 in single-line transfer, the correction for correcting for imperfect transfer in the second output circuit 8 is carried out but not the correction for correcting for imperfect transfer in the first output circuit 7.

On the basis of these settings, correction for imperfect transfer of signal charge is performed with regard to the video signal that is output from the CCD 1 (step 14).

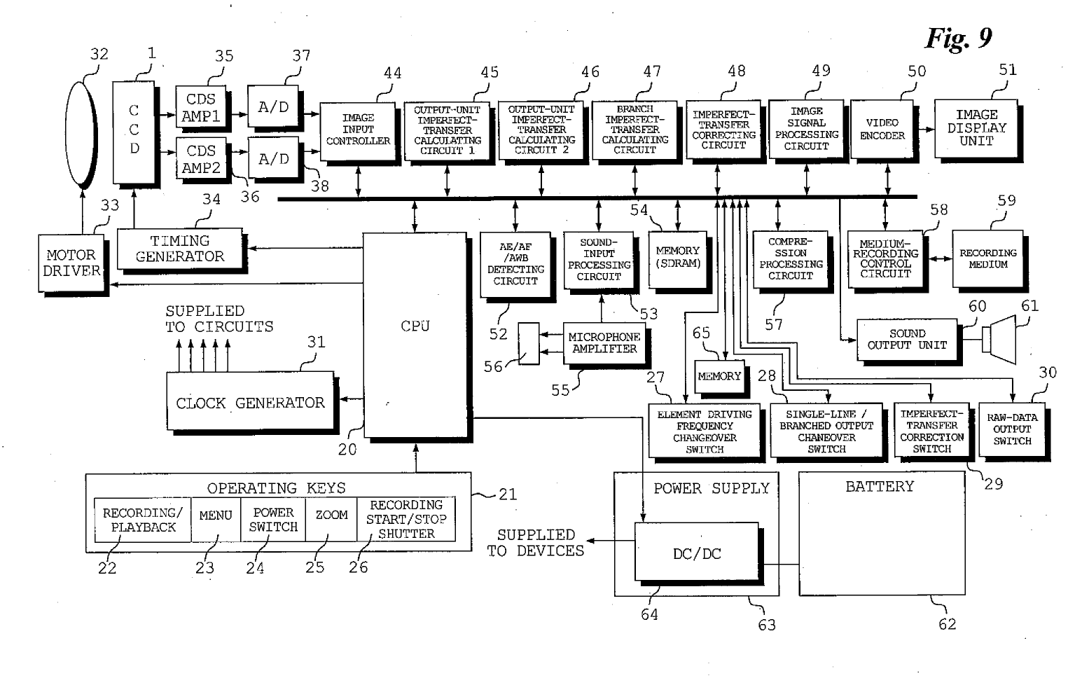

FIG. 9 is a block diagram illustrating the electrical configuration of a digital still camera. The calculation of amount of correction and the application of the correction described above can be implemented in this digital still camera.

The operation of the overall digital still camera is controlled by a CPU 20.

The digital still camera includes various operating keys 21. Operating signals from these operating keys 21 are input to the CPU 20. The various operating keys 21 includes a mode setting switch 22 for setting a recording mode or playback mode, a menu switch 23, a power switch 24, a zoom switch 25 and a recording start/stop shutter switch 26. The digital still camera is provided with a changeover switch 27 for changing over the element driving frequency of the CCD 1, a changeover switch 28 for changing over between single-line transfer and branched transfer described above, an imperfect-transfer correction switch 29 for setting whether the imperfect-transfer correction is to be applied, and a switch 30 for setting a RAW data output. Signals that are output from the switches 27 to 30 are also input to the CPU 20.

The digital still camera includes a battery 62. Power that is output from the battery 62 is applied to a DC/DC converter 64 contained in a power supply circuit 63. The circuits constituting the digital still camera are supplied with power from the DC/DC converter 64. Further, a clock generator 31 is controlled by the CPU 20 and supplies a clock signal to the circuits constituting the digital still camera.

An imaging lens 32 positioned by a motor driver 33 is provided in front of the CCD 1 and is freely movable along the optic axis. When the image of a subject is sensed, the image of the subject is formed on the photoreceptor surface of the CCD 1 by the imaging lens 32. The CCD 1 is driven by driving pulses that are output from a timing generator 34. (These pulses include a gate pulse that shifts signal charge from photodiodes to a vertical transfer line, a vertical transfer pulse, a horizontal transfer pulse and a branching pulse for the branching operation in the branching portion 9.)

A first CDS (correlated doubling sampling) circuit 35 and a second CDS circuit 36 are connected to the CCD 1. In a case where the branched transfer is performed as described above, the first video signal that has been output from the CCD 1 is input to the first CDS circuit 35 and is converted to first digital image data in a first analog/digital converting circuit 37. The first digital image data obtained by the conversion is input to an image input controller 44. The second video signal that has been output from the CCD 1 is input to the second CDS circuit 36 and is converted to second digital image data in a second analog/digital converting circuit 38. The second digital image data obtained by the conversion is also input to an image input controller 44. In a case where single-line transfer is performed, the first CDS circuit 35 outputs a video signal but not the second CDS circuit 36. The video signal that has been output from the first CDS circuit 35 is converted to digital image data in the first analog/digital converting circuit 37 and the digital image data is input to the image input controller 44.

In order to calculate an amount of correction, the CCD 1 is driven in such a manner that signal charge will exist at a ratio of one column to three columns, as illustrated in FIGS. 4A to 4E, FIGS. 5A to 5E and FIGS. 7A to 7F. From image data thus obtained by driving the CCD 1, image data representing imperfect transfer in the first output circuit 7 and image data representing imperfect transfer in the second output circuit 8 (these items of image data are obtained by branched transfer) is input to a first output-unit imperfect-transfer calculating circuit 45, which proceeds to calculate an amount of correction for imperfect transfer in the first output circuit 7 and an amount of correction for imperfect transfer in the second output circuit 8. Further, image data representing imperfect transfer in the branching portion 9 obtained by branched transfer is input to a branch imperfect-transfer calculating circuit 47, which proceeds to calculate an amount of correction for the branching portion 9 in branched transfer. Furthermore, image data representing signal charge that is the combined result of imperfect transfer in the first output circuit 7 in single-line transfer and imperfect transfer in the branching portion 9 in single-line transfer is input to a second output-unit imperfect-transfer calculating circuit 46, which proceeds to calculate an amount of correction that corrects for the combined result of imperfect transfer in the first output circuit 7 and imperfect transfer in the branching portion 9 in single-line transfer.

Since the amount of imperfect transfer of signal charge depends upon the amount of signal charge, amounts of correction conforming to amounts of signal charge (i.e., conforming to the levels of image data) are calculated in the circuits 45 to 47. Data representing the amounts of correction calculated is stored in a memory 65. Specifically, data stored in the memory 65 is data representing the amount of correction for imperfect transfer in the first output circuit 7 in branched transfer (this data is the same as data representing the amount of correction for imperfect transfer in the first output circuit 7 in single-line transfer), data representing the amount of correction for imperfect transfer in the second output circuit 8 in branched transfer, data representing the amount of correction for imperfect transfer in the branching portion 9 in branched transfer, and data representing the amount of correction for imperfect transfer in the first output circuit 7 in single-line transfer (this amount of correction includes an amount of correction for imperfect transfer in the branching portion 9 in single-line transfer).

In a case where the image of a subject is sensed, the CCD 1 undergoes normal drive, namely drive that differs from drive for calculating amount of correction for imperfect transfer. This normal drive would be branched transfer in a case where rapid read-out is required and would be single-line transfer in a case where rapid-read-out is not required. Image data that has been input to the image input controller 44 by normal drive is applied to an AE/AF/AWB detecting circuit 52 by the image input controller 44. Data-necessary for automatic exposure, automatic focus and automatic white balance adjustment is detected in the AE/AF/AWB detecting circuit 52. Automatic exposure control, automatic focus control and automatic white balance adjustment is carried out based upon the detected data.

The image data is input to a video encoder 50, whence the image data is applied to an image display unit 51 to display the image of the subject on the image display unit 51.

If the shutter switch of the recording start/stop shutter switch 26 is pressed, image data obtained in the manner described above is applied to a memory 54 by the image input controller 44 and is stored in the memory 54 temporarily. The image data is read out of the memory 54 and is then input to an imperfect-transfer correcting circuit 48. Of the data representing amounts of correction that has been stored in the memory 54, data representing an amount of correction corresponding to the transfer method (branched transfer or single-line transfer) that prevailed when the image data was obtained is read out and is then corrected in the imperfect-transfer correcting circuit 48. The corrected image data is applied to an image signal processing circuit 49, whereby the data is subjected to prescribed image processing. Image data that has been output from the image signal processing circuit 49 is compressed in a compression processing circuit 57. The compressed image data is recorded on a recording medium 59 by a medium-recording control circuit 58.

The digital still camera is further provided with a microphone 56. A voice signal that is output from the microphone 56 is amplified by a microphone amplifying circuit 55. The amplified voice signal is converted to digital sound data by a sound-input processing circuit 53. The sound data obtained by the conversion can also be stored on the recording medium 59. The digital still camera is further provided with a sound-output processing circuit 60 and a speaker 61, thereby making an audio output possible.

In the embodiment described above, imperfect transfer is corrected for when image data is recorded on the recording medium 59. However, it may be so arranged that the correction is applied when the image of a subject is displayed.

In the embodiment described above, imperfect transfer in the branching portion 9 is not corrected for in the case of single-line transfer. However, it is also possible to correct for both imperfect transfer in the first output circuit 7 (or second output circuit 8) and imperfect transfer in the branching portion 9 even in case of single-line transfer, as will be described below.

As illustrated in FIGS. 7A to 7F, amounts of correction for both imperfect transfer in the first output circuit 7 at the time of single-line transfer and imperfect transfer in the branching portion 9 in a case where the branching operation is not performed have been calculated and stored in memory 65. Further, as illustrated in FIGS. 4A to 4E and FIGS. 5A to 5F, amounts of correction for imperfect transfer in the first output circuit 7 and for imperfect transfer in the second output circuit 8 in branched transfer also have been stored in the memory 65. In case of single-line transfer, not only a correction for imperfect transfer in the first output circuit 7 but also a correction for imperfect transfer in the branching portion 9 in single-line transfer can be applied by applying a correction using amounts of correction for both imperfect transfer in the first output circuit 7 and imperfect transfer in the branching portion 9 in a case where the branching operation is not carried out.

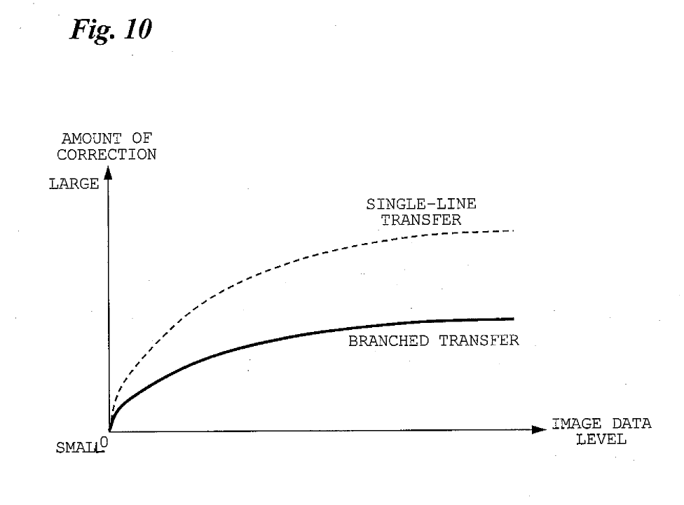

FIG. 10 is a graph indicating amount of correction in case of single-line transfer and amount of correction for the first output circuit 7 or second output circuit 8 in branched transfer.

In the case of single-line transfer, not only correction for imperfect transfer in the first output circuit 7 but also correction for imperfect transfer in the branching portion 9 in single-line transfer is performed at the same time. The amount of correction, therefore, is greater than the amount of correction for imperfect transfer in the first output circuit 7 or second output circuit 8 in branched transfer. The amount of correction for imperfect transfer in the first output circuit 7 and second output circuit 8 in branched transfer does not include the amount of correction for imperfect transfer in the branching portion 9 in a case where branched transfer is carried out (correction for imperfect transfer in the branching portion 9 in a case where branched transfer is performed is carried out separately) and therefore is smaller than the amount of correction in case of single-line transfer.

By using such an amount of correction, imperfect transfer in single-line transfer is corrected for and a correction is made for imperfect transfer in the first output circuit 7 and second output circuit 8.

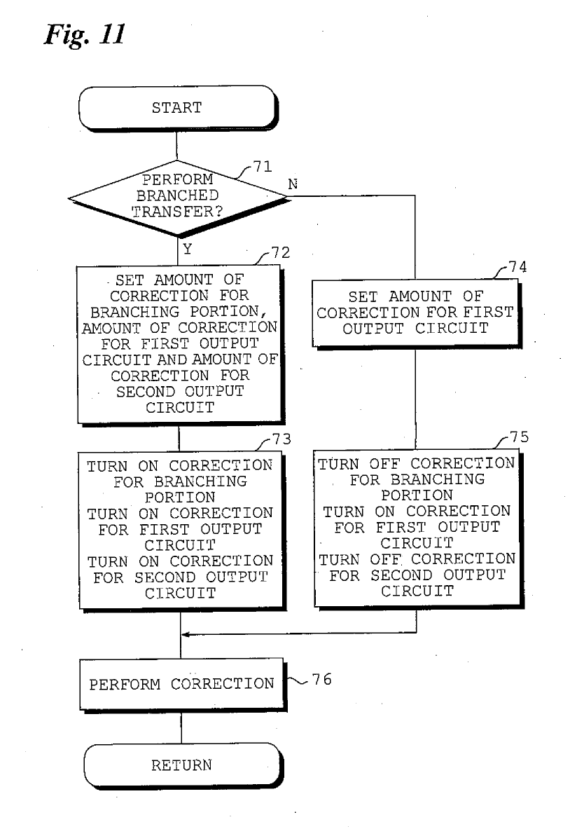

FIG. 11 is a flowchart illustrating processing whereby a correction is made not only for imperfect transfer in the first output circuit 7 but also for imperfect transfer in the branching portion 9 in single-line transfer.

First, whether transfer is branched transfer or single-line transfer is determined (step 71). In case of branched transfer, data representing amount of correction for imperfect transfer in the branching portion 9 in branched transfer, amount of correction for imperfect transfer in the first output circuit 7 and amount of correction for imperfect transfer in the second output circuit 8 is read from the memory 65 and the data representing these amounts of correction is set in the imperfect-transfer correcting circuit 48 (step 72). The amount of correction for imperfect transfer in the first output circuit 7 and the amount of correction for imperfect transfer in the second output circuit 8 do not include amount of correction for branched transfer in the branching portion 9. It is set so that correction for imperfect transfer in case of branched transfer in the branching portion 9, correction for imperfect transfer in the first output circuit 7 and correction for imperfect transfer in the second output circuit 8 is carried out (step 73). The set corrections are performed in the imperfect-transfer correcting circuit 48 (step 76).

In case of single-line transfer, data representing amount of correction for correcting for imperfect transfer in the first output circuit 7 is read from the memory 65 and set in the imperfect-transfer correcting circuit 48 (step 74). It is set so that correction for imperfect transfer in the branching portion 9 and correction for imperfect transfer in the second output circuit 8 is not carried out and so that correction for imperfect transfer in the first output circuit 7 is carried out (step 75). The set correction for imperfect transfer in the first output circuit 7 is applied (step 76). The amount of correction for imperfect transfer in the first output circuit 7 in single-line transfer does not include an amount of correction for imperfect transfer in the branching portion 9 in single-line transfer, as mentioned above. Accordingly, by applying a correction for imperfect transfer in the first output circuit 7 in single-line transfer, a correction for imperfect transfer in the branching portion 9 in single-line transfer also is carried out simultaneously.

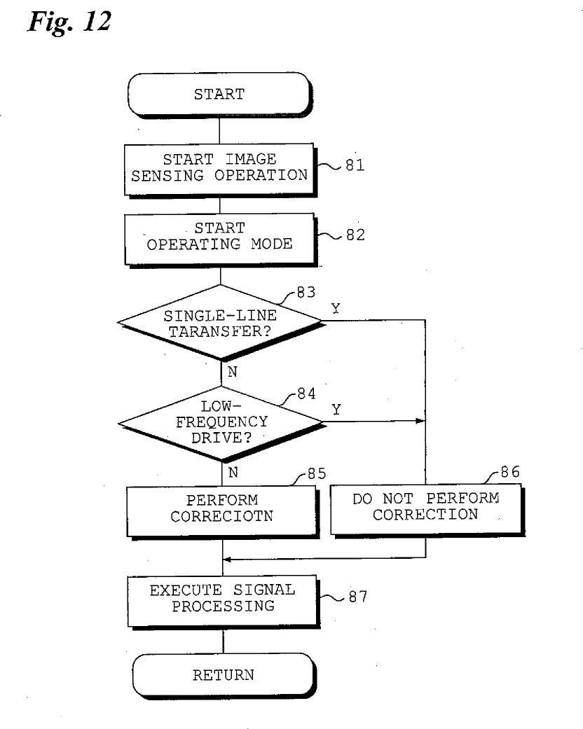

FIG. 12 illustrates another embodiment of the present invention. This is a flowchart illustrating processing executed when an image sensing operation is performed by the digital still camera. Here it is assumed that data representing amount of correction has already been stored in the memory 65.

The image of a subject is sensed (step 81) and the driving mode is selected by the changeover switch 28 for changing over between single-line transfer and branched transfer and changeover switch 27 for changing over the element driving frequency (step 82).

In a case where single-line transfer has been set by the changeover switch 28 for changing over between single-line transfer and branched transfer (“YES” at step 83), it is considered that the amount of signal charge resulting from imperfect transfer in the branching portion 9 is small and that the amount of signal charge resulting from imperfect transfer in the first output circuit 7 is not so large as to affect image quality, and hence the above-described correction is not carried out. Even in a case where branched transfer has been set (“NO” at step 83), if low-frequency drive is set by the changeover switch 27 for changing over the element driving frequency (“YES” at step 84), then the amount of signal charge resulting from imperfect transfer will be smaller in comparison with high-frequency drive. As a result, the above-described correction for imperfect transfer is not carried out (step 86). This makes it possible to conserve electric power.

If branched transfer has been set (“NO” at step 83) and low-frequency drive has not been set (“NO” at step 84), then the above-described correction for imperfect transfer in branched transfer is carried out (step 87).

Prescribed signal processing is applied to the image data that has been corrected or to the image data that has not been corrected (step 87).

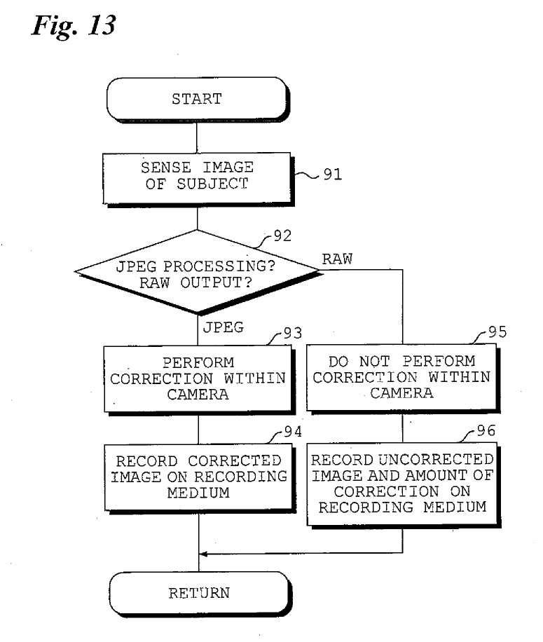

FIG. 13 is a flowchart illustrating processing executed when an image sensing operation is performed by the digital still camera according to yet another embodiment of the present invention. By virtue of this processing, if compression processing [e.g., compression based upon the JPEG (Joint Photographic Experts Group) standard but not limited to JPEG compression] is carried out, the image data is subjected to a correction within the camera and is then recorded on the recording medium. If RAW data is output, the image is not subjected to a correction within the camera and is recorded on the recording medium along with data representing the amount of correction.

The image of a subject is sensed (step 91) and it is determined whether JPEG compression is to be executed or RAW data is to be output (step 92).

If output of RAW data has not been selected by the RAW-data output switch 30, then JPEG compression is carried out (step 92) and the above-described correction is performed within the camera (step 93). The corrected image data is recorded on the recording medium 59 (step 94).

If output of RAW data has been selected by the RAW-data output switch 30, then the above-described correction is not performed within the camera (step 95). This makes it possible to reduce processing within the camera. Data representing amount of correction conforming to branched transfer or single-line transfer is read out of the memory 65 and recorded on the recording medium 59 together with the uncorrected RAW data (step 96). By loading the recording medium 59 in a personal computer or the like, the RAW data can be corrected by utilizing the data representing the amount of correction that has been recorded on the recording medium 59. Since the correction can be performed by an external device such as a personal computer, a correction processing program executed by the external device can be upgraded to a later version comparatively simply and a correction of improved correction accuracy can be implemented.

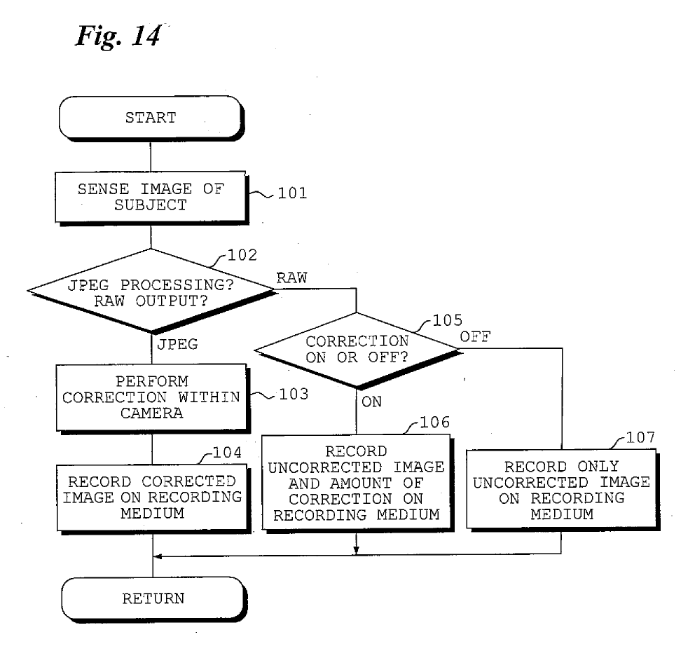

FIG. 14 is a flowchart illustrating processing executed by the digital still camera according to yet another embodiment of the present invention. Here a correction is applied in accordance with the setting of a correction on/off switch.

The image of a subject is sensed and image data is obtained (step 101). It is determined whether JPEG compression is to be carried out or RAW data is to be output (step 102). If JPEG compression is to be carried out, a correction is performed within the camera (step 103). The corrected image data is recorded on the recording medium (step 104). If RAW data is to be output, it is determined whether implementation of a correction has been set by the imperfect-transfer correction switch 29 (i.e., whether correction ON or OFF is determined) (step 105). In case of correction ON, the RAW data is recorded on the recording medium 59 and data representing the amount of correction is recorded on the recording medium 59 in association with branched transfer or single-line transfer (step 106). In case of correction OFF, image data is recorded on the recording medium 59 but data representing amount of correction is not recorded on the recording medium 59 (step 107).

As many apparently widely different embodiments of the present invention can be made without departing from the spirit and scope thereof, it is to be understood that the invention is not limited to the specific embodiments thereof except as defined in the appended claims.

What is claimed is:

1. An apparatus for correcting a solid-state electronic image sensing device having a number of optoelectronic transducers provided in horizontal and vertical directions; a horizontal transfer line, which is provided with a branching portion that branches signal charge in two directions, for transferring one line of signal charge at a time, the signal charge having accumulated in the number of optoelectronic transducers; a first amplifying circuit for converting signal charge, which is output from one of the signal charges branched in the two directions at the branching portion, to a first video signal and then outputting the first video signal; and a second amplifying circuit for converting signal charge, which is output from the other of the signal charges branched in the two directions at the branching portion, to a second video signal and then outputting the second video signal; said apparatus comprising:
a driving device responsive to a branching operation command for driving the branching portion in such a manner that the signal charge transferred on the horizontal transfer line is applied to the first amplifying circuit or second amplifying circuit alternatingly, and responsive to a single-line operation command for driving the branching portion in such a manner that the signal charge transferred on the horizontal transfer line is input to either the first amplifying circuit or second amplifying circuit alone; and
a first correcting device responsive to the branching operation command for applying a correction, which is based upon imperfect transfer of signal charge at the branching portion, to the first video signal that is output from the first amplifying circuit and to the second video signal that is output from the second amplifying circuit, and responsive to the single-line operation command for halting the correction, which is based upon imperfect transfer of signal charge at the branching portion, applied to the video signal that is output from either the first amplifying circuit or second amplifying circuit alone.

2. The apparatus according to claim 1, further comprising a second correcting device responsive to the branching operation command for applying a correction, which is based upon imperfect transfer of signal charge in the first amplifying circuit, to the first video signal that is output from the first amplifying circuit, and applying a correction, which is based upon imperfect transfer of signal charge in the second amplifying circuit, to the second video signal that is output from the second amplifying circuit, and responsive to the single-line operation command for canceling the halting of the correction, which is based upon imperfect transfer of signal charge at the branching portion, applied to the video signal that is output from either the first amplifying circuit or second amplifying circuit alone, and applying a correction based upon imperfect transfer of signal charge in whichever of the first or second amplifying circuit has output the video signal.

3. The apparatus according to claim 1, wherein when transfer driving frequency of signal charge on the horizontal transfer line is less than a prescribed threshold value, said first correcting device halts the correction, which is based upon imperfect transfer of signal charge at the branching portion, to be applied in response to the branching operation command.

4. The apparatus according to claim 1, further comprising an output device responsive to the branching operation command for outputting the first video signal that is output from the first amplifying circuit, the second video signal that is output from the second amplifying circuit, and a correction parameter for applying the correction based upon imperfect transfer of signal charge at the branching portion.

5. The apparatus according to claim 4, wherein said output device halts the output of the correction parameter when the transfer driving frequency of signal charge on the horizontal transfer line is less than a prescribed threshold value.

6. A method of correcting a solid-state electronic image sensing device having a number of optoelectronic transducers provided in horizontal and vertical directions; a horizontal transfer line, which is provided with a branching portion that branches signal charge in two directions, for transferring one line of signal charge at a time, the signal charge having accumulated in the number of optoelectronic transducers; a first amplifying circuit for converting signal charge, which is output from one of the signal charges branched in the two directions at the branching portion, to a first video signal and then outputting the first video signal; and a second amplifying circuit for converting signal charge, which is output from the other of the signal charges branched in the two directions at the branching portion, to a second video signal and then outputting the second video signal; said method comprising the steps of:
in response to a branching operation command, driving the branching portion by a driving device in such a manner that the signal charge transferred on the horizontal transfer line is applied to the first amplifying circuit or second amplifying circuit alternatingly, and in response to a single-line operation command, driving the branching portion by the driving device in such a manner that the signal charge transferred on the horizontal transfer line is input to either the first amplifying circuit or second amplifying circuit alone; and
in response to the branching operation command, applying, by a correcting device, a correction, which is based upon imperfect transfer of signal charge at the branching portion, to the first video signal that is output from the first amplifying circuit and to the second video signal that is output from the second amplifying circuit, and in response to the single-line operation command, halting, by the correcting device, the correction, which is based upon imperfect transfer of signal charge at the branching portion, applied to the video signal that is output from either the first amplifying circuit or second amplifying circuit alone.
